(19) United States
(12) Patent Application Publication
(10) Pub. No.: US 2004/0262924 A1
(43) Pub. Date: Dec. 30, 2004

(54) Marine propulsion unit

(76) Inventor: Bernd Wacker, Herzogenaurach (DE)

Correspondence Address: HARNESS, DICKEY & PIERCE, P.L.C., P.O.BOX 8910, RESTON, VA, 20195, US

(21) Appl. No.: 10/497,147

(22) PCT Filed: Nov. 28, 2002
(86) PCT No.: PCT/DE02/04381

(30) Foreign Application Priority Data
Nov. 30, 2001 (DE) 101 58 805.4

(51) Int. Cl. B60L 11/02; H02K 23/60

(52) U.S. Cl. 290/20

(57) ABSTRACT

A marine propulsion unit has at least one electric motor, at least one propulsion unit, which may be driven by the at least one electric motor and an energy generation unit (5), by means of which the at least one electric motor may be supplied with electrical energy and which comprises a gas turbine (6) as driving unit and a generator (7), driven by the gas turbine (6), for generation of electrical energy. According to the invention, such a marine propulsion unit may be embodied with increased efficiency, reduced mass and reduced weight with the same power, whereby the gas turbine (6) is directly connected to the generator (7) without a gearbox and the generator (7) is embodied as a synchronous unit with a high-temperature superconducting pole winding, which is arranged in a cryostat, cooled by a cryogenic unit (8).

This application is the national phase under 35 U.S.C. § 371 of PCT International Application No. PCT/DE02/04381 which has an International filing date of Nov. 28, 2002, which designated the United States of America and which claims priority on German Patent Application numbers DE 101 58 805.4 filed Nov. 30, 2001, the entire contents of which is hereby incorporated herein by reference.

### FIELD OF THE INVENTION

The invention generally relates to a marine propulsion system.

### BACKGROUND OF THE INVENTION

In known marine propulsion systems, in which a gas turbine is used as a drive machine for the power generating system, a reduction gearbox is in each case arranged between the gas turbine and the generator, in order to optimize the balance between the rotation speed, the compression ratio, the mechanical design and efficiency. In this case, the gearbox transmission ratio becomes higher the higher the rotation speed and the smaller the gas turbine. This results in a considerable adverse effect on the gearbox efficiency, since this efficiency falls exponentially as the transmission ratio is increased.

DE-A-2 237 400 discloses a marine propulsion system having at least one electric motor, at least one propulsion system, which can be driven by the at least one electric motor, and having a power generating system, by which the at least one electric motor can be supplied with electrical power, and which has a gas turbine as a drive machine, and a generator, which is driven by the gas turbine, in order to generate electrical power, with the gas turbine being coupled without any gearbox to the generator, and with the generator being a synchronous machine.

### SUMMARY OF THE INVENTION

An embodiment of the invention includes an object of designing and using a marine propulsion system such that the efficiency of its power generating system is considerably increased. Further, its mass and its weight preferably can be considerably reduced while not changing the drive power.

According to an embodiment of the invention, an object may be achieved by a generator having an HTSC (high-temperature superconductor) pole winding, arranged in a cryostat that is cooled by a cryogenic cooling system. Further, the marine propulsion system may be arranged on board a liquefied natural gas tanker, a liquid nitrogen tanker, a liquid hydrogen tanker or the like, and liquefied natural gas, liquid nitrogen, liquid hydrogen or the like can be used in its cryogenic cooling system as the coolant for its cryogenic cooling device(s).

The marine propulsion system according to an embodiment of the invention does not make use of the power supply system frequencies of 50 or 60 Hz which are normally provided for such applications. The lack of any mechanical reduction gearbox results in the high-speed generators being more reliable, more efficient, less noisy, lighter in weight, and having fewer auxiliaries such as oil coolers, pumps, etc. and achieving reduced costs overall. The configuration of the generator as a synchronous machine and its equipment according to an embodiment the invention with an HTSC pole winding make it possible to design the generator to have a rating which is expedient for marine propulsion systems and is normally between 2 MW and 100 MW.

The armature ampere turns and the air-gap induction can be increased to the desired extent, owing to the presence of the HTSC pole winding, with reasonable generator rotor part dimensions. The generator, which is in the form of a synchronous machine with an HTSC pole winding, for the marine propulsion system according to an embodiment of the invention, itself generates the required wattless components, in contrast to a synchronous machine with permanent magnet excitation, and it has a higher utilization coefficient while its rotor part can be designed to be more compact. A generator such as this allows efficiencies of more than 99% to be achieved. Liquefied natural gas, liquid nitrogen, liquid hydrogen or the like may be used with little financial cost as a coolant for the cryogenic cooling system for the marine propulsion system.

According to one advantageous embodiment, the power generating system of the marine propulsion system according to an embodiment of the invention may have at least two gas turbines, which each have an associated generator for generating electrical power.

The HTSC pole winding is advantageously arranged on a rotor part of the generator. In order to further increase the generator rating despite the comparatively small surface area available for cooling, it is expedient for the generator to have a stator part with HTSC windings, which are arranged in a cryostat that is cooled by the cryogenic cooling system. According to an embodiment of the invention, this makes it possible to achieve air-gap inductions of more than 2 T.

Owing to the increased armature ampere turns which can be achieved according to an embodiment of the invention, it is possible for the stator part of the generator not to have any iron slots, according to a further embodiment of the marine propulsion system according to the invention. All that is provided is an iron yoke for the magnetic return path.

The generator of the marine propulsion system according to an embodiment of the invention may have two or more windings, which are designed such that they are swiveled, on its stator part or stator. If, owing to the lack of the normal power supply system frequencies of 50 Hz or 60 Hz, the generator is connected to a DC voltage power supply system by way of rectifiers, then this results in little ripple being produced in the DC voltage on the DC voltage side.

The magnitude of the DC voltage can be set. This can be done by controllable excitation of the generator with the HTSC pole winding. This allows the quality of the voltage of the DC voltage circuit to be influenced.

According to one advantageous embodiment of the marine propulsion system according to the invention, liquid helium, liquid neon and liquid nitrogen in vaporized form may be used, for example, as the cryogenic cooling coolant.

It should be noted that liquefied natural gas, liquid nitrogen and liquid hydrogen have a boiling temperature of −162 degrees C., −196 degrees C. and −253 degrees C., respectively, at a pressure of 1 bar; the corresponding boiling temperatures of liquid neon and liquid helium are −246 degrees C. and −269 degrees, respectively.

Furthermore, the gas turbine of the marine propulsion system according to an embodiment of the invention can be operated by way of a vaporized liquefied natural gas.

The cold energy which is produced during the vaporization of the liquefied natural gas can expediently be used for cooling further appliances, for example the stator part of the generator, converters, cooling systems for refrigerated goods, air-conditioning systems etc.

The generator in the marine propulsion system according to an embodiment of the invention is advantageously followed by converters or rectifiers, preferably diode rectifiers, by which the high generation frequency, which is in the range up to 400 Hz, of the generator can be used to form a DC voltage power supply system. The frequency generated by the generator may, for example, be 102 Hz, 131 Hz, 183 Hz, 208 Hz or 375 Hz.

The loads are expediently connected to the DC voltage power supply system via inverters.

If a heat exchanging unit is arranged in a fuel supply line from the liquid fuel tank to the gas turbine, it is possible to cool the cryogenic coolant, for example liquid nitrogen, for the cryogenic cooling system by the liquid fuel in this heat exchanging unit. It is possible to operate a mixed cooling machine or to provide heat plates.

A second heat exchanging unit is advantageously provided in the fuel supply line from the liquid fuel tank to the gas turbine, in which second heat exchanging unit, combustion air, which is supplied to the gas turbine through a combustion air supply line, can be cooled by the liquid fuel, or the liquefied natural gas can be heated by the combustion air.

If a third heat exchanging unit is arranged in the fuel supply line, the coolant for a cooling system for energy conversion can be cooled by this.

The coolant for a cooling apparatus for foodstuffs or the like may be cooled by a further, fourth heat exchanging unit.

According to a further expedient embodiment of the marine propulsion system according to the invention, a fifth heat exchanging unit is arranged in the fuel supply line from the liquid fuel tank to the gas turbine, by which fifth heat exchanging unit a cooling water circuit which is associated with the generator and/or the coolant for an air-conditioning system or the like can be cooled.

A sixth heat exchanging unit can be used to heat the fuel by way of steam and/or water which are/is recirculated in a water and steam circuit between the outlet side and the inlet side of a steam turbine which is associated with the generator.

The fuel is advantageously supplied to burners for the gas turbine via a fuel charging unit.

For the starting process or when no heat exchanging units are currently available, it is expedient for the fuel charging unit to be connected by way of a line branch to the downstream side of the second heat exchanging unit, with a superheater being arranged in this line branch, by which the fuel can be heated to the temperature that is suitable for combustion in the gas turbine.

In order to provide a standard fuel storage device, it is also expedient for a gas motor to be connected to the fuel charging unit, by which gas motor a standby or emergency generator can be driven. This makes it possible to provide the starting mode, the standby mode, for example for harbor operation, and the emergency mode. There may be two or more such gas motors.

Furthermore a fuel cell stack may be provided, which may likewise be operated using natural gas and which can carry out the same tasks as the gas motor.

A seventh heat exchanging unit is expediently arranged in an outlet line from the gas turbine, by which seventh heat exchanging unit thermal energy from the exhaust gas from the gas turbine can be transferred to the water and steam circuit of the steam turbine, downstream from the sixth heat exchanging unit and upstream of the inlet to the steam turbine.

This seventh heat exchanging unit may advantageously be equipped as a boiler with an additional burner that is operated by natural gas, in which case there is then no need to operate the gas turbine for operation of the seventh heat exchanging unit.

A further heating circuit can advantageously be supplied with thermal energy from the exhaust gas from the gas turbine in the seventh heat exchanging unit, in which case this heating circuit can be used for conditioning water, for operation of a swimming bath, for an air-conditioning system, for a laundry, for food preparation or the like.

According to a further advantageous embodiment, the power generating system of the marine propulsion system according to the invention has a further electricity power supply system, which is a conventional 50 Hz or 60 Hz AC power supply system.

The DC voltage power supply system of the power generating system may be connected via an AC/DC converter to the conventional 50 Hz or 60 Hz AC power supply system.

The AC/DC converter may have one or more rotating or static converters.

If the marine propulsion system according to an embodiment of the invention has an additional independent diesel generator set as the drive unit for its power supply, it is advantageous for the diesel engine in the at least one diesel generator set to be connected to the combustion air supply line to the gas turbine.

Furthermore, the diesel engine in the at least one diesel generator set maybe integrated in the heating circuit which is connected to the seventh heat exchanging unit.

In principle, it is possible to use liquefied or vaporized natural gas, liquid or gaseous hydrogen, liquid or gaseous nitrogen or the like as a coolant or fuel, provided that the marine propulsion system according to an embodiment of the invention is arranged on board a ship with a corresponding liquid fuel tank.

### BRIEF DESCRIPTION OF THE DRAWINGS

Further advantages, features and details of the invention will become evident from the description of illustrated exemplary embodiments given hereinbelow and the accompanying drawings, which are given by way of illustration only and thus are not limitative of the present invention, wherein:

FIG. 1 shows a basic illustration of a power generating system from a first embodiment of a marine propulsion system according to the invention;

FIG. 2 shows an embodiment, modified from that shown in FIG. 1, for the power generating system for the marine propulsion system according to the invention;

FIG. 3 shows a first embodiment of an electrical power supply system for the marine propulsion system according to the invention; and

FIG. 4 shows an embodiment, modified from that shown in FIG. 3, of the electrical power supply system of the marine propulsion system according to the invention.

### DETAILED DESCRIPTION OF THE PREFERRED EMBODIMENTS

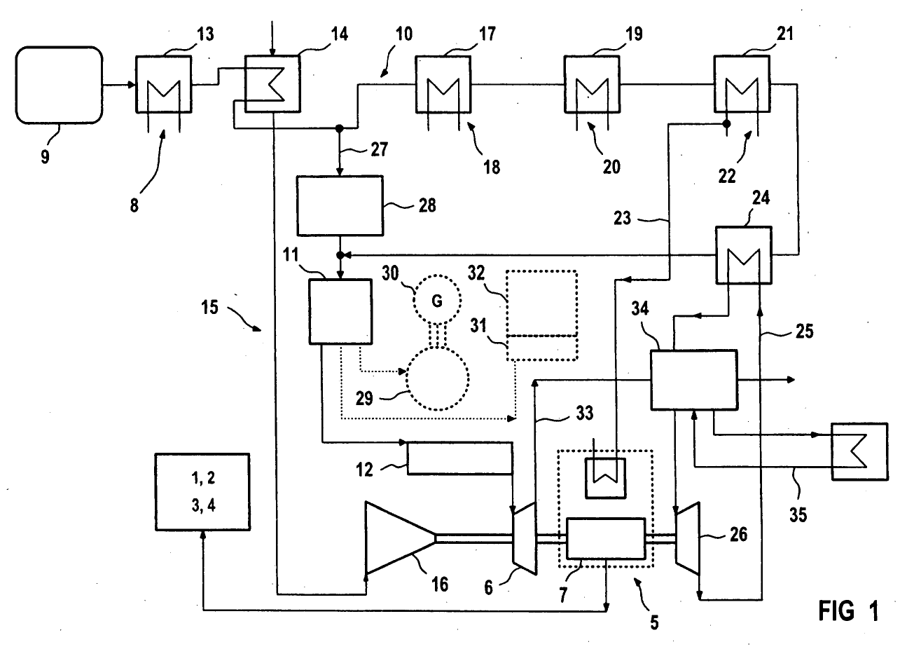

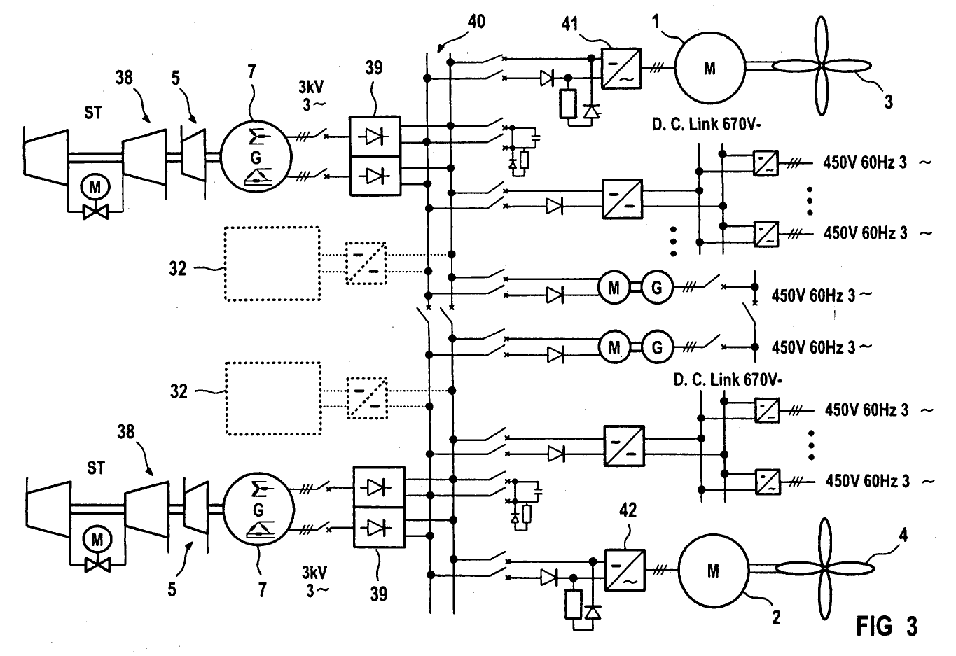

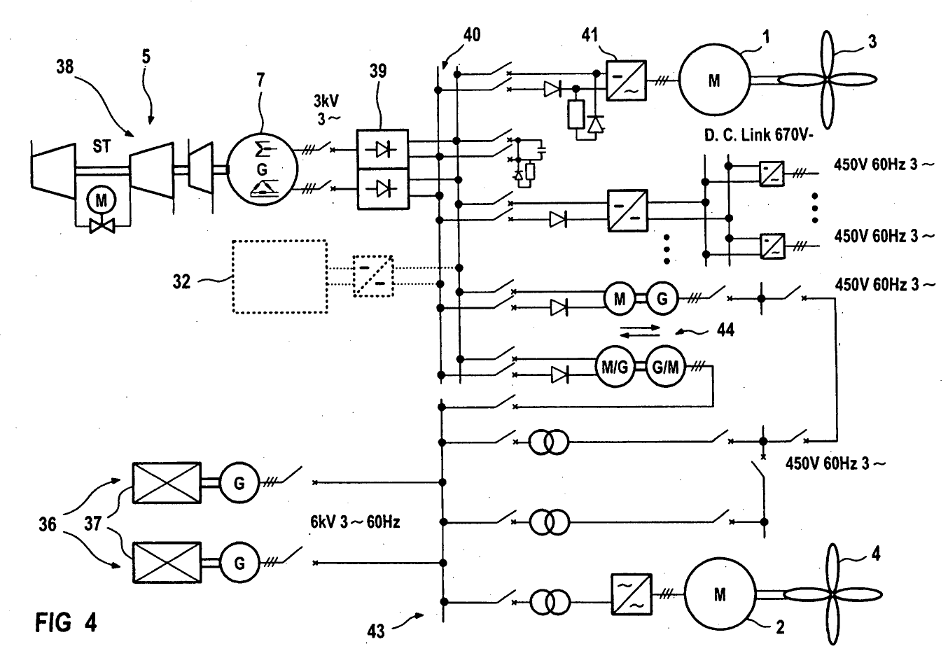

A marine propulsion system according to the invention, a number of alternative embodiments of which are illustrated in FIGS. 1 to 4, has, as can be seen from FIGS. 3 and 4, two electric motors 1, 2 each of which—in the illustrated embodiment—drives a propulsion system that is formed by a respective ship propeller 3 or 4.

In the embodiment of the marine propulsion system according to the invention illustrated in FIG. 1, the electric motors 1, 2 are supplied with electrical power by a power generating system 5, which has a gas turbine 6 as the drive machine.

The gas turbine 6 is connected without any gearbox directly to a rotor part of a generator 7.

On its rotor part, the generator 7 has an HTSC (high-temperature superconductor) pole winding, which is arranged in a cryostat which is itself cooled by way of a cryogenic cooling system 8, which is illustrated only in outline form in FIG. 1.

In the exemplary embodiment of the marine propulsion system shown in FIG. 1, this is a component of a liquefied natural gas tanker with a liquefied natural gas tank 9. Natural gas which is initially in liquefied form and which is taken from the liquefied natural gas tank 9 is used as the fuel for the gas turbine 6.

Alternatively, of course, it is possible to use liquid hydrogen instead of liquefied natural gas as the fuel.

As already mentioned above, in the case of the exemplary embodiment shown in FIG. 1, the gas turbine 6 is powered by natural gas which is taken from the liquefied natural gas tank 9. For this purpose, the liquefied natural gas is supplied through a fuel supply line 10 to a fuel charging unit 11, by which the natural gas can be supplied to burners 12 for the gas turbine 6.

The liquefied natural gas is vaporized in the fuel supply line 10 by way of apparatus parts which will be described in the following text, with the cold energy that is produced being used not only to operate the cryogenic cooling system 8 but also for cooling further appliances, for example the stator part of the generator 7, converters, cooling systems for refrigerated goods, air-conditioning systems etc.

Close to its end on the liquefied natural gas tank side, a first heat exchanging unit 13 is provided in the fuel supply line 10, in which first heat exchanging unit 13 the coolant for the cryogenic cooling system 8, which may, for example, be liquid nitrogen, can be cooled by the liquefied natural gas.

Downstream from the first heat exchanging unit 13 in the flow direction of the natural gas, a second heat exchanging unit 14 is arranged in the fuel supply line 10 and is integrated in a combustion air supply line 15, through which combustion air is passed to an air inlet for a compressor 16 of the gas turbine 6. In the second heat exchanging unit 14, the combustion air (which is at a temperature between −40 degrees C. and +40 degrees C. when it enters the combustion air supply line 15) is used to heat the natural gas.

Downstream from the second heat exchanging unit 14, a third heat exchanging unit 17 is arranged in the fuel supply line, by which third heat exchanging unit the coolant of a cooling system 18 (which is shown only in outline form in FIG. 1) can be cooled for energy conversion.

A fourth heat exchanging unit 19 is arranged downstream from the third heat exchanging unit 17 within the fuel supply line 10, by which fourth heat exchanging unit the coolant of a cooling apparatus 20, which is illustrated only in outline form in FIG. 1, for foodstuffs or the like can be cooled.

A cooling water circuit system 22 can be cooled in a fifth heat exchanging unit 21 which is arranged downstream from the fourth heat exchanging unit 19 in the fuel supply line 10, with this cooling water circuit system 22 having a cooling water circuit 23 which is associated with the generator 7. The rest of the cooling water circuit system 22 is illustrated only in outline form in FIG. 1 and may, for example, be a component of an air-conditioning system or the like.

The natural gas is heated further in a sixth heat exchanging unit 24, which is arranged downstream from the fifth heat exchanging unit 21 in the fuel supply line 10. This sixth heat exchanging unit 24 is integrated in a water and steam circuit 25, which drives a steam turbine 26, which likewise acts on the rotor part of the generator 7. The sixth heat exchanging unit 24 is arranged in this water and steam circuit 25, between the output side and the input side of the steam turbine 26 in the flow direction of the steam and water.

The natural gas is raised in this sixth heat exchanging unit 24 to a temperature which is suitable for combustion. The sixth heat exchanging unit 24 may be a condenser for the steam turbine 26. The natural gas is passed from the sixth heat exchanging unit 24 into the fuel charging unit 11, which is connected upstream of the burners 12.

The fuel charging unit 11 is connected by way of a line branch 27 to that section of the fuel supply line 10 which is arranged downstream from the second heat exchanging unit 14. A superheater 28 is arranged in the line branch 27, by which the natural gas can be heated to the temperature that is suitable for combustion in the gas turbine 6 even once the system described above has been started up or when no heat exchanging unit is currently available.

Apart from being connected to the burners 12 for the gas turbine 6, the fuel charging unit 11 is also connected to a gas motor 29 which, for example, may have a rating of up to 2 MW and which drives a standby or emergency generator 30, which is provided for the starting mode, for the standby mode, for example for harbor operation, and for the emergency mode. Two or more such gas motors 29 may, of course, also be provided.

In addition, in the exemplary embodiment shown in FIG. 1, a fuel cell stack 32 is connected via a reformer 31 to the fuel charging unit 11, which likewise uses natural gas and which, for example, can carry out the same tasks as the gas motor 29.

If, as already described above, liquid hydrogen is used instead of liquefied natural gas, there is no need for the reformer 31 upstream of the fuel cell stack 32.

A seventh heat exchanging unit 34 is arranged in an outlet line 33 from the gas turbine 6. This seventh heat exchanging unit 34, which is in the form of a steam generator in the illustrated exemplary embodiment, is used to extract thermal energy from the exhaust gas from the gas turbine 6 for steam generation in the water and steam circuit 35 that is associated with the steam turbine 26.

The seventh heat exchanging unit 34 is arranged downstream from the sixth heat exchanging unit and upstream of the inlet of the steam turbine 26 within the water and steam circuit 25 of the steam turbine 26. At least one of the seventh heat exchanging unit and the steam generator 34 may also be in the form of a boiler with an additional burner, in which case natural gas may likewise be used as the fuel, and the operation of the gas turbine 6 is not required.

The seventh heat exchanging unit 34 may be used, as in the exemplary embodiment shown in FIG. 1, to supply a further heating circuit 35 with thermal energy from the exhaust gas from the gas turbine 6. This heating circuit 35 may be used for a large number of purposes, for example for conditioning water, for the operation of a swimming bath, for an air-conditioning system, for a laundry, for operating a kitchen, or the like.

The generator 7 may likewise have HTSC windings on its stator part, whose cryostat may likewise be cooled by way of the cryogenic cooling system 8.

On its stator or stator part, the generator 7 may have two or more windings which are designed such that they are swiveled. This results in little ripple in the DC voltage on the DC voltage side. The magnitude of the DC voltage is set by controlling the excitation of the generator 7, which is in the form of a synchronous machine. This makes it possible to influence the quality of the voltage in the DC voltage circuit.

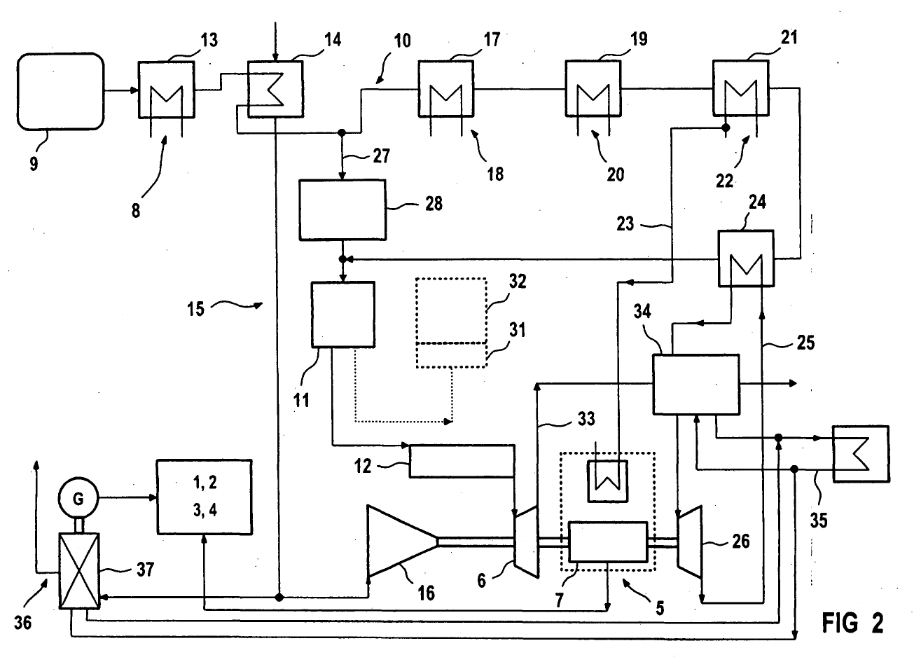

The embodiment of the marine propulsion system according to the invention illustrated in FIG. 2 differs from the embodiment shown in FIG. 1 essentially in that at least one additional independent diesel generator set 36 is provided. Like the embodiment with the gas motor 29 as shown in FIG. 1, a diesel generator set 36 such as this may be used, for example, for the starting mode, for standby operation and for emergency operation. In this embodiment an additional diesel fuel tank is required. The fuel cell stack 32 and the gas motor 29 may nevertheless be provided.

A diesel engine 37 in the diesel generator set 36 is connected, in the embodiment shown in FIG. 2, to the combustion air supply line 15 for the gas turbine 6. Furthermore, the diesel engine 37 is integrated in the heating circuit 35, which is connected to the seventh heat exchanging unit 34. On the one hand, this makes it possible to use the heat losses from the diesel engine 37, while it is being operated, in the heating circuit 35. On the other hand, the diesel engine 37 can be pre-heated in the standby mode.

Two generators 7 are provided in the electrical power supply system (as shown in FIG. 3) for the marine propulsion system, and are operated in the same way by a combined gas and steam turbine system 38. Since the generator 7 in consequence generates a higher frequency than normal, it has an associated converter or rectifier 39, which is in the form of a diode rectifier. This feeds the DC voltage power supply system 40 or the electrical propulsion system for the marine propulsion system.

Loads or equipment connected thereto, for example, the electric motors 1, 2 for the ship propellers 3, 4, are fed from the DC voltage power supply system 40 via inverters 41, 42.

A gas motor may also be connected to the DC voltage power supply system 40, with a converter likewise being used.

Inverters, for example, the inverters 41, 42 which are associated with the electric motors 1, 2, are used to convert the DC voltage from the DC voltage power supply system 40 to an AC voltage, as required by the loads, at the same frequency or at a variable frequency.

In the embodiment of the electrical power supply system of the marine propulsion system according to the invention illustrated in FIG. 4, the power generating system 5 has a conventional 50 Hz or 60 Hz AC voltage power supply system 43 in addition to the DC voltage power supply system 40. The DC voltage power supply system 40 may also have two or more combined gas and steam turbine systems 38 in the embodiment shown in FIG. 4. The AC power supply system 43 is fed by way of two diesel generator sets 36 in the embodiment illustrated in FIG. 4.

The DC voltage power supply system 40 in the power generating system 5 is connected, in the exemplary embodiment shown in FIG. 4, via an AC/DC converter 44 to the conventional AC power supply system 43. The AC/DC converter 44 may have one or more rotating or static converters.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A marine propulsion system, comprising:
at least one electric motor;
at least one propulsion system, which can be drivable by the at least one electric motor, and including a power generating system adapted to supply electrical power to the at least one electric motor and including a gas turbine as a drive machine and a generator, driven by the gas turbine, for generation of electrical power, wherein the gas turbine is coupled without any gearbox directly to the generator and wherein the generator is a synchronous machine and includes
an HTSC (high-temperature superconductor) pole winding, arranged in a cryostat cooled by a cryogenic cooling system, and wherein the marine propulsion system is arranged on board at least one of a liquefied natural gas tanker, a liquid nitrogen tanker, and a liquid hydrogen tanker, and wherein at least one of liquefied natural gas, liquid nitrogen, and liquid hydrogen is used as a coolant in the cryogenic cooling system.

2. The marine propulsion system as claimed in claim 1, wherein the power generating system includes at least two gas turbines, each including an associated generator for generating electrical power.

3. The marine propulsion system as claimed in claim 1, wherein the HTSC pole winding is arranged on a rotor part of the generator.

4. The marine propulsion system as claimed in claim 1, wherein the generator includes HTSC windings on a stator part, arranged in a cryostat cooled by the cryogenic cooling system.

5. The marine propulsion system as claimed in claim 4, wherein the stator part of the generator includes no iron slots.

6. The marine propulsion system as claimed in claim 1, wherein at least one of a stator part and a stator of the generator includes at least two windings, designed to be swiveled.

7. The marine propulsion system as claimed in claim 1, wherein the excitation of the generator is controllable with the HTSC pole winding.

8. The marine propulsion system as claimed in claim 1, wherein at least one of the liquid nitrogen, liquid helium and liquid neon are provided in a vaporized form.

9. The marine propulsion system as claimed in claim 1, wherein the marine propulsion system is arranged on board a liquefied natural gas tanker, whose gas turbine is operatable by use of a vaporized liquefied natural gas.

10. The marine propulsion system as claimed in claims 1, wherein cold energy is produced during the vaporization of the liquefied natural gas, usable for cooling further devices.

11. The marine propulsion system as claimed in claim 1, wherein the generator is followed by at least one of converters and rectifiers, by which a high generation frequency, in the range up to 400 Hz, of the generator is usable to form a DC voltage power supply system.

12. The marine propulsion system as claimed in claim 11, wherein loads are connected to the DC voltage power supply system via inverters.

13. The marine propulsion system as claimed in claim 1, wherein a heat exchanging unit is arranged in a fuel supply line from a liquid fuel tank to the gas turbine, and wherein, in the heat exchanging unit, the cryogenic coolant for the cryogenic cooling system is coolable by the liquid fuel tank.

14. The marine propulsion system as claimed in one of claim 1, wherein a second heat exchanging unit is arranged in the fuel supply line from the liquid fuel tank to the gas turbine, and wherein in the second heat exchanging unit combustion air, supplied to the gas turbine through a combustion air supply line, is coolable by the liquid fuel tank.

15. The marine propulsion system as claimed in claim 14, wherein a third heat exchanging unit is arranged in the fuel supply line from the liquid fuel tank to the gas turbine, and wherein, by the third heat exchanging unit, the coolant of a cooling system for energy conversion is coolable.

16. The marine propulsion system as claimed in claim 15, wherein a fourth heat exchanging unit is arranged in the fuel supply line from the liquid fuel tank to the gas turbine, and wherein, by the fourth heat exchanging unit, the coolant of a cooling apparatus for foodstuffs is coolable.

17. The marine propulsion system as claimed in claim 16, wherein a fifth heat exchanging unit is arranged in the fuel supply line from the liquid fuel tank to the gas turbine, and wherein, by the fifth heat exchanging unit, at least one of a cooling water circuit associated with the generator and the coolant for an air-conditioning system is coolable.

18. The marine propulsion system as claimed in claim 17, wherein a sixth heat exchanging unit is arranged in the fuel supply line from the liquid fuel tank to the gas turbine, and wherein by the sixth heat exchanging unit, the fuel is heatable by at least one of steam and water, which is recirculated in a water and steam circuit between the outlet side and the inlet side of a steam turbine associated with the generator.

19. The marine propulsion system as claimed in claim 18, wherein a fuel charging unit is arranged immediately upstream of the burners for the gas turbine, in the fuel supply line, from the liquid fuel tank to the gas turbine.

20. The marine propulsion system as claimed in claim 19, wherein the fuel charging unit is connected via a line branch to the downstream side of the second heat exchanging unit, and wherein a superheater is arranged, by which the fuel is heatable to a temperature suitable for combustion in the gas turbine.

21. The marine propulsion system as claimed in claim 19, wherein a gas motor is connected to the fuel charging unit, and wherein at least one of a standby and emergency generator is drivable by the gas motor.

22. The marine propulsion system as claimed in claim 18, wherein a fuel cell stack is connected to the fuel charging unit via a reformer.

23. The marine propulsion system as claimed in claim 18, wherein a seventh heat exchanging unit is arranged in an outlet line from the gas turbine, and wherein by the seventh heat exchanging unit, thermal energy from the exhaust gas from the gas turbine is transferred to the water and steam circuit of the steam turbine, downstream from the sixth heat exchanging unit and upstream of the inlet to the steam turbine.

24. The marine propulsion system as claimed in claim 23, wherein the seventh heat exchanging unit is equipped as a boiler with an additional burner operated by natural gas.

25. The marine propulsion system as claimed in claim 23, wherein a further heating circuit is suppliable with thermal energy from the exhaust gas from the gas turbine in the seventh heat exchanging unit, wherein the further heating circuit is usable for conditioning water.

26. The marine propulsion system as claimed in claim 1, wherein the power generating system includes a further electricity power supply system.

27. The marine propulsion system as claimed in claim 26, wherein a DC voltage power supply system of the power generating system is connected via an AC/DC converter to a conventional AC power supply system.

28. The marine propulsion system as claimed in claim 27, wherein the AC/DC converter includes at least one rotating converters.

29. The marine propulsion system as claimed in claim 27, wherein the AC/DC converter includes at least one static converter.

30. The marine propulsion system as claimed in claim 1, wherein at least one additional independent diesel generator set is provided.

31. The marine propulsion system as claimed in claim 30, wherein a diesel engine in the at least one diesel generator set is connected to the combustion air supply line to the gas turbine.

32. The marine propulsion system as claimed in claim 2, wherein the HTSC pole winding is arranged on a rotor part of the generator.

33. The marine propulsion system as claimed in claim 1, wherein cold energy is produced during the vaporization of the liquefied natural gas, usable for cooling at least one of the stator part of the generator, converters, cooling systems for refrigerated goods, and air-conditioning systems.

34. The marine propulsion system as claimed in claim 20, wherein a gas motor is connected to the fuel charging unit, and wherein at least one of a standby and emergency generator is drivable by the gas motor.

35. The marine propulsion system as claimed in claim 23, wherein a further heating circuit is suppliable with thermal energy from the exhaust gas from the gas turbine in the seventh heat exchanging unit, wherein the further heating circuit is usable for conditioning water, for operation of at least one of a swimming bath, an air-conditioning system, a laundry, and food preparation.

36. The marine propulsion system as claimed in claim 26, wherein the further electricity power supply system is a conventional at Hz AC power supply system.

37. The marine propulsion system as claimed in claim 36, wherein a DC voltage power supply system of the power generating system is connected via an AC/DC converter to the conventional AC power supply system.
